(19) United States
(12) Patent Application Publication
(10) Pub. No.: US 2017/0146144 A1
(43) Pub. Date: May 25, 2017

(54) VALVE COMPRISING AN IMPROVED VALVE BODY AND METHOD FOR PRODUCING SUCH A VALVE

(71) Applicant: Valeo Systemes de Controle Moteur, Cergy - Pontoise (FR)

(72) Inventors: Sylvain Gautier, Ennery (FR); Frédéric Ribera, Acheres (FR)

(73) Assignee: Valeo Systemes de Controle Moteur, Cergy - Pontoise (FR)

(21) Appl. No.: 15/300,029

(22) PCT Filed: Mar. 31, 2015
(86) PCT No.: PCT/FR2015/050830

§ 371 Date: Sep. 28, 2016

(30) Foreign Application Priority Data
Apr. 1, 2014 (JP) 1452880

(51) Int. Cl. F16K 27/02; F02M 26/67; F02M 26/53; F02M 26/73; F16K 31/04; F16K 49/00

(52) U.S. Cl. CPC F16K 27/02; F16K 31/047; F16K 49/005; F02M 26/53; F02M 26/73; F02M 26/67

(57) ABSTRACT

The invention relates to a valve (1), such as a valve for a motor vehicle and, in particular, an exhaust gas recirculation valve, comprising a valve body (2) including at least one housing (34; 15) for receiving a member (20) of the valve, preferably two housings (34, 15) for receiving valve members, said member(s) preferably having a substantially tubular shape, the base of the housing(s) (34; 15) having at least one rib (40, 42), preferably at least two ribs (40, 42), in contact with the valve member (20). The invention also relates to a method for the production of such a valve.

The invention relates to a valve notably intended for the automotive field and to a method for manufacturing such a valve. In particular, the valve may be an exhaust gas recirculation, or EGR, valve.

In general, an exhaust gas recirculation system for an internal combustion engine makes it possible to reduce the amount of nitrogen oxides (NOx) present in the exhaust gases. Such an EGR system conventionally comprises a recirculation duct on the gas exhaust line, this bypass duct being fitted with a valve, referred to as an EGR valve, that makes it possible to regulate the flow and return the desired quantity of exhaust gas to the intake side of the engine.

The valve comprises a body in which there is formed a passage which forms a portion of the recirculation duct, it being possible for the passage to be closed off selectively. The valve also comprises a component that controls the opening and closing of the passage. The control component is actuated by an electric motor which may also be housed inside the body.

A known control component takes the form of a toothed-sector wheel driven in rotation by an output pinion of the electric motor, possibly via a transmission wheel. The rotations of the toothed-sector wheel are therefore converted into translational movements of a valve head with respect to a seat of the valve, which seat is arranged in the passage, by means of a movement conversion device. Such a movement conversion device is, for example, described in application FR-A-2 947 027 in the name of the applicant company. The movement conversion device comprises first of all a skirt as one in terms of rotation with the toothed-sector wheel. The skirt drives the rotation of a linkage comprising a bar fitted with followers at its ends. The bar is as one in terms of translation with a stem which at its end bears the valve head. The followers are housed in a camway of a barrel cam (or cylindrical cam) in such a way that rotation of the toothed-sector wheel causes a translational movement of the valve head with respect to the valve seat. Furthermore, a return spring may be provided in order to return the toothed-sector wheel to a determined position and/or in order to keep the toothed-sector wheel in this position when there is no actuation of the valve by the actuating motor.

For a valve of this type to operate correctly it is important for the cam to be positioned accurately.

Specifically, if the cam is not perfectly positioned, there is a risk that the stem will be likewise incorrectly positioned. As a result, it is possible that the valve head may not rest over the entire periphery of the valve seat and that the valve will thus remain partially open.

In order to obtain accurate positioning for the cylindrical cam of the valve provision may be made for the cam to be housed in a housing formed in the cam body, the bottom of the housing intended to accept this cam potentially then being machined, after the valve body has been molded. This method is lengthy and expensive. Indeed it is necessary to obtain a housing bottom surface that is perfectly planar and suited to the bottom of the cylindrical cam.

Furthermore, in the case of an EGR valve, because the exhaust gases are relatively hot, it is known practice for water to be circulated in the EGR valve body in order to cool it. In that case, one or more water circulation passages may be provided in the valve body, which passages may be suited to being placed in fluidic communication with passages for the circulation of water in the cylinder head of the engine. The water circulation passages may be close to the housing accommodating the cylindrical cam. As a result, notably when the valve body is produced by high-pressure die casting, the machining of the bottom of the housing may create leakage paths between the housing accommodating the cam and the water circulation passage. This may detract from the integrity of the valve by causing corrosion or even a short circuit.

The same set of problems are encountered with any housing formed in a valve body intended to accept a valve component, such as the valve actuating motor for example.

It is therefore an object of the invention to propose a solution to the problems mentioned hereinabove. In particular, the invention seeks to propose a valve comprising a valve body that allows a component of the valve such as an actuating motor or a cylindrical cam of the valve, for example, to be placed in an accurate position. For preference, the solution proposed limits the risks of a loss of sealing being introduced into the valve.

To this end, the invention proposes a valve, notably for a motor vehicle, particularly an exhaust gas recirculation valve, comprising a valve body with a housing to accommodate a component of the valve, the component preferably being of substantially tubular shape, the bottom of the housing having at least one rib, preferably at least two ribs, in contact with the component of the valve.

Thus, advantageously, according to the invention, the position of the valve component housed in the housing is defined precisely by only the ribs in the bottom of the housing. Thus, in particular, only these ribs potentially need to be machined in order to obtain an even more precise positioning of the valve component. The valve according to the invention is therefore quicker and therefore less expensive to manufacture. Furthermore, because it is only the ribs that are potentially machined, the risks of leakage within the valve, notably in the bottom of the housing, are reduced.

The valve member advantageously rests only on this or these ribs, which are in relief, projecting from the bottom of the housing.

For preference, the valve body according to the invention has one or more of the following features, considered alone or in combination:
the component is chosen from:
   a valve actuating motor, preferably an electric motor, and
   a cam with a camway for converting the rotational movement of a member controlling the opening of the valve into a reciprocating movement of a valve head in a duct;
the valve further comprises:
   a linkage intended to be driven in rotation, guided by the camway, and
   a valve stem as one in terms of translation with the linkage and the valve head;
the valve body is produced by high-pressure die casting and machining of the rib or ribs only;
the valve body further comprises a duct for the circulation of valve cooling fluid;
the valve body comprises at least one threaded hole, preferably at least two threaded holes opening into the bottom of the housing, the threaded hole or holes accepting a fixing screw for fixing the valve component, notably the cam, to the valve body;
at least one rib has the shape of an “M”, the web of each “M” preferably forming a portion of the border of one of the threaded holes;
the bottom of the housing that accepts the cam has a hole for the passage of the valve stem, preferably substantially at the center of the bottom of the housing;
the housing comprises a plurality of ribs, the ribs being evenly angularly distributed;
the rib or ribs extend from the lateral wall of the housing;
the rib or ribs extend radially over the bottom of the housing, preferably over a length less than half the radius of the bottom of the housing;
the housing is substantially tubular, preferably substantially cylindrical;
the valve further comprises a component controlling the rotation of the linkage as one in terms of rotation with the linkage and driven in rotation by the rotation of the actuating motor; and
the actuating motor comprises an outlet shaft as one in terms of rotation with a pinion, the control component comprising a toothed-sector wheel, meshing with the pinion, potentially via reduction gearing that reduces the rotational speed of the motor, the toothed-sector wheel being as one in terms of rotation with the linkage.

Another aspect of the invention relates to a method of manufacturing a valve as described hereinabove in all combinations thereof, comprising the steps involving:
molding, preferably using high-pressure die casting, the valve body in order therein to form a housing, preferably substantially tubular, having a bottom with at least one rib; and
inserting into the housing at least one component of the valve, preferably an assembly comprising at least the cam, the linkage housed in the camway of the cam, and the valve stem.

For preference, the method of manufacture further comprises a step, subsequent to the step of molding the valve body, that involves machining only the surface of the rib or ribs.

The invention will be better understood in the light of the description which will follow, which description is given with reference to the attached drawings among which:

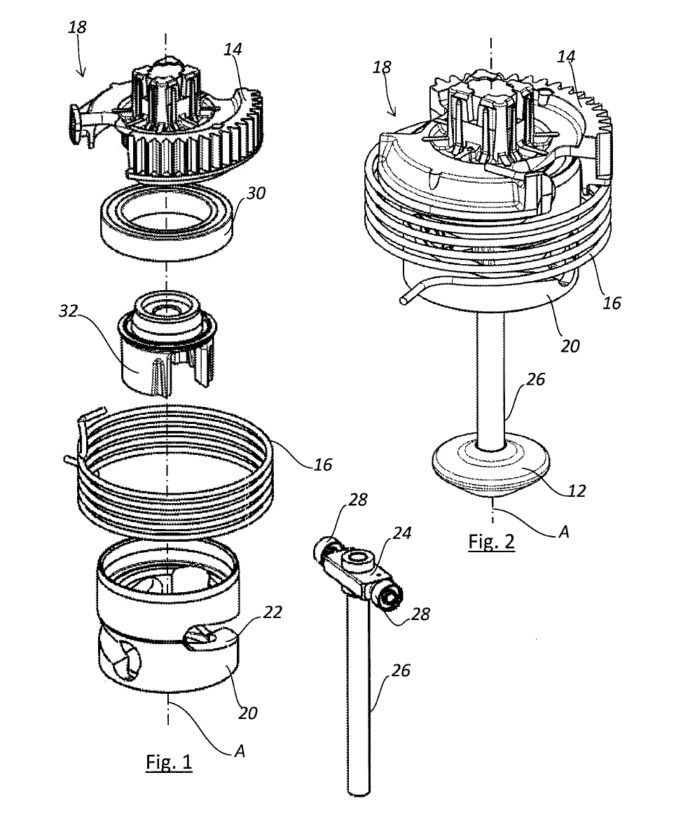

FIGS. 1 and 2 are schematic perspective depictions of a movement conversion device for an EGR valve, these respectively being an exploded and an assembled view;

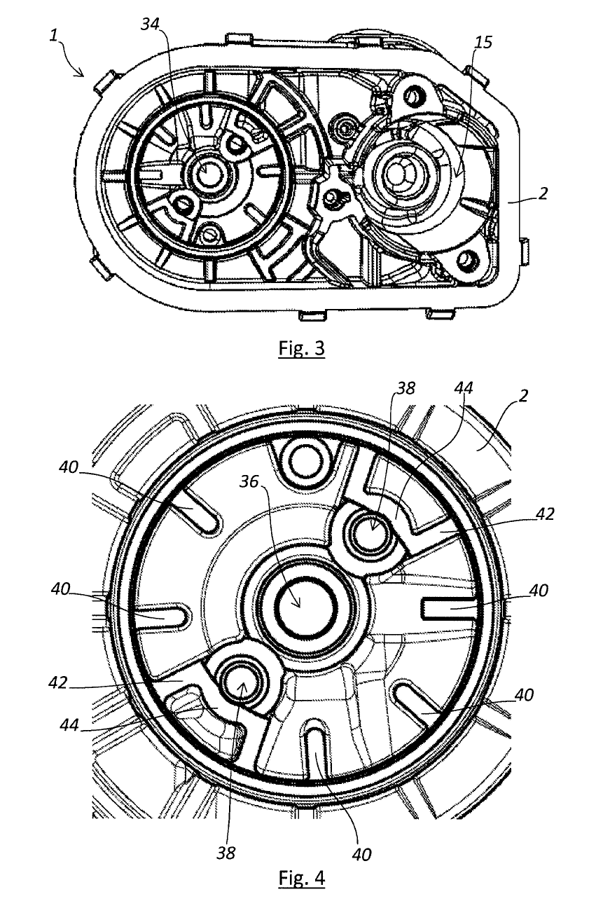

FIG. 3 schematically depicts a view from above of a body of an EGR valve; and

FIG. 4 depicts a detail of the view of FIG. 3.

As illustrated in the figures, an EGR valve 1 comprises a valve body 2 forming a passage for the circulation of exhaust gas that is to be recirculated. The valve body also here forms a water circulation passage for the cooling water for cooling the valve. The valve body 2 also has holes for attaching the valve to a power unit of a motor vehicle. Such fixing holes may notably be produced in flanges or collars surrounding the mouths of the cooling water circulation passage thus allowing the cooling water circulation passage of the valve to be integrated into the cooling water circulation passage of the engine to which the valve is attached. Such fixing holes may also be made in flanges or collars surrounding the mouths of the exhaust gas recirculation passage.

Such a valve moreover comprises, as illustrated in FIGS. 1 and 2, a valve head 12 which allows a fluid, in this instance the exhaust gases, to be introduced and metered into a pipe, in this instance the intake pipe. The valve is of the type comprising a control component 14 rotating against the action of a return spring 16 operating in torsion.

The valve 1 also comprises a motor which may be mounted in a housing 15 (cf. FIG. 3) formed by the valve body 2. The motor engages a transmission wheel. The transmission wheel in turn engages the control component 14, in this instance a toothed-sector wheel. The motor is thus able to drive the toothed-sector wheel 14 in rotation.

The rotational movement of the toothed-sector wheel 14 is converted into a reciprocating movement of the valve head 12 by virtue of a movement conversion device 18. A reciprocating movement here means a movement comprising a translational movement along an axis, which may potentially be combined with a rotation with respect to this same axis.

The movement conversion device 18 for this purpose comprises, inside a support member formed by the valve body, a cam 20 with a camway 22 (or cylindrical cam), a bar 24 (or linkage) collaborating with the camway 22 of the cylindrical cam 20, the bar 24 being fixed to the end of a stem 26 secured to the valve head 12. In order to guide the stem 26 in the valve body, one or a number of bearings may be provided between the stem 26 and the valve body. A clearance may be provided between the stem 26 and the bar 24 so as to allow the stem to rotate with respect to the bar, about the axis of the stem, the bar and the stem being as one in terms of translational movement in the direction of the axis of the stem.

The camway 22 here is formed of two identical tracks, one on each side of a tubular wall of the cylindrical cam 20. The bar 24 is equipped at each of its ends with a follower 28 collaborating with the camway so that when the toothed-sector wheel 14 is driven in rotation, this wheel in turn drives the rotation of the bar 24 causing, thanks to the path of the followers 28 in the camway 22, the translational or at least reciprocating movement of the valve head 12. The valve head 12, the stem 26 and the bar 24 are as one in terms of translation in the direction of the axis A of movement of the valve head 12, this translational movement responding to the rotation of the toothed-sector wheel 14 about this same axis A.

Arranged between the toothed-sector wheel 14 and the cylindrical cam 20 is a bearing 30, in this instance a ball bearing, to allow the toothed-sector wheel 14 to rotate with respect to the cylindrical cam 20.

Moreover, the toothed-sector wheel 24 is as one in terms of rotation with a skirt 32 intended to collaborate with the bar 24. This skirt 32 comprises two longitudinal walls which are symmetric and which extend essentially parallel to the direction A of rotation of the toothed-sector wheel 14 and of translation of the valve head 12. The two longitudinal walls between them define a housing for the bar 24. Thus, the bar 24 is arranged in the housing in such a way that the toothed-sector wheel 14 is able to drive the rotation of the bar 24 via the longitudinal walls of the skirt 32, and that the bar 24 is free to slide in the housing in the direction of translational movement of the valve head 12.

As a result, within the valve, rotation of the toothed-sector wheel 14 causes rotation of the bar 24 the followers 28 of which then run along the camway 22 of the cylindrical cam 20, which is fixed, which jointly leads to a movement of the valve head 12 in the direction of the axis A, of movement of the valve head 12 and of rotation of the toothed-sector wheel 14, between a position of the valve head 12 that corresponds to the valve being closed and at least one position of the valve head that corresponds to the valve being open, it being understood that to each position of the valve head 12 there corresponds a unique distinct angular position of the toothed-sector wheel 14.

In order to return the valve head 12 to the position in which the valve is closed, and/or keep it in this position in the absence of actuation by the motor, the toothed-sector wheel 14 is connected to the support component by means of a return spring 16 operating in torsion. Thus, the opening of the valve 10 is brought about by the rotation of the toothed-sector wheel 14, the control component, itself brought about by the rotation of the motor, the actuating component, against the action of a return force applied to the toothed-sector wheel 14 by the return spring 16.

The return spring 16 here is a helical spring of axis A corresponding to the axis of rotation of the toothed-sector wheel 14. The return spring 16 is connected, at one end, to the support member and, at the other end, to the toothed-sector wheel 14, so that rotation of the toothed-sector wheel 14 to command the opening of the valve introduces torsion into the return spring 16. In particular, the return spring 16 may be connected to the support component by the fact that one of its ends, bent back in the opposite direction to the rest of the helicoidal winding of the return spring 16, is housed in a hole in the support component or collaborates with an end stop formed for that purpose by the return spring 16. The return spring 16 here is housed in a substantially cylindrical housing delimited by the support component, the cylindrical cam 22 and the toothed-sector wheel 14.

With the motor switched off, the return spring 16 applies a return force that returns the toothed-sector wheel 14 to its position corresponding to the position in which the valve is closed. This position of the toothed-sector wheel 14 corresponding to the valve being closed, may correspond to a preloaded state of the return spring 16. In other words, when the toothed-sector wheel 14 is in the position that corresponds to the valve being closed, the return spring 16 applies a force to the toothed-sector wheel 14 that has a tendency to cause it to turn. However, rotation of the toothed-sector wheel 14 beyond the position corresponding to the valve being closed is prevented because the valve head 12 is in abutment against a valve seat.

The way in which the cylindrical cam 20 is housed in a cam housing 34, provided for that purpose in the valve body 2, will now be described more specifically with reference to FIGS. 4 and 5 more particularly.

The cam housing is of a shape that substantially complements the cylindrical cam 20 and of a diameter substantially equal to the outside diameter of the cylindrical cam 20, this being so to allow the cylindrical cam 20 to be inserted into the cam housing 34, the cylindrical cam 20 being fitted into the cam housing 34 in order to contribute to accurate positioning of the cylindrical cam 20.

Furthermore, the bottom of the cam housing 34 has a disk-shaped central opening 36 for the passage of the valve stem 26. The bottom of the cam housing 34 also has two threaded holes 38 for fixing screws that fix the cylindrical cam 20 to the valve body 2.

Finally, the bottom of the cam housing 34 has ribs 40, 42. The ribs 40, 42 are oriented essentially radially, which means to say in directions extending from the center of the bottom of the cam housing 34 towards the cylindrical lateral wall. The ribs 40, 42 here extend radially over a length less than half the radius of the cam housing 34.

Furthermore, the ribs 40, 42 have a height with respect to the bottom of the housing of at least 1 mm so as to allow them to be machined without the risk of obtaining a flat bottom surface for the housing. The width of the ribs is approximately 2 mm so that the cam can be supported effectively.

The ribs are of two different types here. A first type of ribs 40 extends practically exclusively radially. These ribs preferably have a free end of rounded cross section, notably in the form of a half disk, for reasons of ease of production of these ribs using molding.

The ribs 42 of the second type have an M-shape emanating from the cylindrical wall of the cam housing 34. The web 44 of the “M” corresponds to the edge of a screw hole 38, in order better to take up the forces of the screw heads and ensure the effectiveness of the connection of the cam 20 to the valve body 2. What is meant here by the “web of the M” is the part that connects the tops of the two vertical branches of an “M” and so here the part connecting the two radial portions of the ribs 42.

The cylindrical cam 20 rests only on the ribs 40, 42 in relief projecting out from the bottom of the cam housing 34. Thus, only the perpendicularity with the axis of translation of the valve head, of the zones of contact between the cylindrical cam 20 and these ribs 40, 42 needs to be obtained accurately (rather than the perpendicularity of the entirety of the bottom of the cam housing 34). It then limits the zone that needs to be machined accurately to these ribs alone, constituting a time saving and therefore a reduction in the cost of manufacture. Furthermore, because these ribs extend over a short length, the amount of surface that needs to be machined is further limited.

Furthermore, advantageously, the valve body 2 described hereinabove is produced by high-pressure die casting, for example from an aluminum alloy. Specifically, such high-pressure casting is very rapid, notably of the order of a few tenths of a millisecond, compared with gravity casting. However, the surface of the ribs 40, 42 is machined in order to give them a surface finish that allows the position of the cylindrical cam 20 housed in the cam housing 34 to be defined with precision. With preference, only the surface of the ribs is machined. This notably makes it possible to limit the risk of leakages in the bottom of the cam housing 34. Specifically, it is known that high-pressure die casting creates a skin effect which seals a surface. However, machining this surface has a tendency to destroy this fluid-tight skin and allow a porous structure, having the propensity to leak, to become visible at the surface. By limiting the zone machined to the ribs only, the portion of the bottom of the housing that exhibits a porous surface is limited, particularly in comparison with a known method in which the entire surface is machined. Furthermore, the machined surface is limited here to the parts with an increased thickness of material, this then further limiting the creation of leakage paths, in comparison with the known method described hereinabove.

Of course, the present invention is not restricted to the description that has just been described but numerous alternative forms are possible without departing from the scope of the invention defined by the set of claims.

Thus, the depicted example of a cam housing has six ribs, two of them in the shape of an “M”. Of course this number is nonlimiting, and neither is the type. It is for example possible to conceive of having only grooves 40 running practically only radially or only M-shaped grooves. The number of these grooves is not limiting either.

However, for the sake of the homogeneity of the support afforded the cylindrical cam on the ribs in the bottom of the cam housing, the ribs are preferably evenly angularly distributed and/or arranged substantially symmetrically with respect to the center of the bottom of the cam housing.

Finally, the scenario of a housing to accommodate a cam has been described hereinabove by way of example. Of course, the teaching hereinabove applies to any housing for accepting a valve component, preferably a tubular or even cylindrical component of the valve, such as the actuating motor that operates the valve, for example.

It may also comprise several housings all or just some of which may be of the cam housing type described hereinabove.

1. An exhaust gas recirculation valve for a motor vehicle, comprising:
a valve body with a housing to accommodate a substantially tubular component of the valve,
the bottom of the housing having at least two ribs, in contact with the component of the valve.

2. The valve as claimed in claim 1, in which the component is chosen from:
a valve actuating electric motor, and
a cam with a camway for converting the rotational movement of a member controlling the opening of the valve into a reciprocating movement of a valve head in a duct.

3. The valve as claimed in claim 2, further comprising:
a linkage intended to be driven in rotation, guided by the camway; and
a valve stem as one in terms of translation with the linkage and the valve head.

4. The valve as claimed in claim 1, in which the valve body is produced by high-pressure die casting and machining of the rib or ribs only.

5. The valve as claimed in claim 1, in which the valve body further comprises a duct for the circulation of valve cooling fluid.

6. The valve as claimed in claim 2, in which the valve body comprises at least two threaded holes opening into the bottom of the housing, the threaded holes accepting a fixing screw for fixing the cam to the valve body.

7. The valve as claimed in claim 6, in which at least one rib has the shape of an “M”, the web of each “M” forming a portion of the border of one of the at least two threaded holes.

8. The valve as claimed in claim 1, the component being a cam with a camway , in which valve the bottom of the housing that accepts the cam has a hole for the passage of the valve stem substantially at the center of the bottom of the housing.

9. The valve as claimed in claim 1, in which the housing comprises a plurality of ribs, the ribs being evenly angularly distributed.

10. The valve as claimed in claim 1, in which the rib or ribs extend from the lateral wall of the housing.

11. The valve as claimed in claim 1, in which the rib or ribs extend radially over the bottom of the housing over a length less than half the radius of the bottom of the housing.

12. The valve as claimed in claim 1, in which the housing is substantially cylindrical.

13. The valve as claimed in claim 11, further comprising a component controlling the rotation of the linkage as one in terms of rotation with the linkage and driven in rotation by the rotation of the actuating motor.

14. The valve as claimed in claim 13, in which the actuating motor comprises an outlet shaft as one in terms of rotation with a pinion, the control component comprising a toothed-sector wheel, meshing with the pinion, potentially via reduction gearing that reduces the rotational speed of the motor, the toothed-sector wheel being as one in terms of rotation with the linkage.

15. A method of manufacturing a valve as claimed in claim 1, comprising:
molding, using high-pressure die casting, the valve body in order therein to form at least one substantially tubular housing, having a bottom with at least one rib; and
inserting into the housing an assembly comprising at least a cam, a linkage housed in a camway of the cam, and a valve stem.

16. The method of manufacturing a valve as claimed in claim 15, further comprising, subsequent to the step of molding the valve body, machining only the surface of the rib or ribs.
